(19) United States
(12) Patent Application Publication
(10) Pub. No.: US 2024/0318655 A1
(43) Pub. Date: Sep. 26, 2024

(54) ELECTRIC COMPRESSOR

(71) Applicant: KABUSHIKI KAISHA TOYOTA JIDOSHOKKI, Kariya-shi (JP)

(72) Inventors: Yuya Hattori, Kariya-shi (JP); Masaki Shibata, Kariya-shi (JP)

(73) Assignee: KABUSHIKI KAISHA TOYOTA JIDOSHOKKI, Kariya-shi (JP)

(21) Appl. No.: 18/606,501

(22) Filed: Mar. 15, 2024

(30) Foreign Application Priority Data
Mar. 24, 2023 (JP) 2023-048902

(51) Int. Cl. F04C 18/02; H02K 1/18; H02K 11/33

(52) U.S. Cl. CPC F04C 18/0215; H02K 1/185; H02K 11/33; F04C 2240/30; F04C 2240/403

(57) ABSTRACT

An electric compressor includes a housing, a driving shaft, an electric motor, and a compression mechanism. The housing includes a first housing and a second housing. The electric motor includes a stator and a rotor. The first housing has a first end surface. The second housing has a second end surface. The first housing and the second housing are fixed by a first fastener. The stator is fixed to the first end surface by a second fastener. The first end surface has a first hole through which the first fastener is inserted and a second hole in which the second fastener is fixed.

### BACKGROUND ART

This application claims priority to Japanese Patent Application No. 2023-048902 filed on Mar. 24, 2023, the entire disclosure of which is incorporated herein by reference.

The present disclosure relates to an electric compressor.

Japanese Patent Application Publication No. 2000-097168 discloses a conventional electric compressor. This electric compressor includes a housing, a compression mechanism, an electric motor, and a driving shaft. The housing includes a first housing and a second housing. The first housing and the second housing extend in an axial direction of the electric compressor. The first housing has a first end surface facing the second housing in the axial direction. A first hole and a second hole are formed in the first end surface. On the other hand, the second housing has a second end surface facing the first end surface in the axial direction. A through hole is also formed in the second housing. The through hole extends through the second housing in the axial direction.

The first housing and the second housing are fixed with each other in the axial direction of the electric compressor by a first fastener. Here, the first fastener is fixed in the first hole. In this way, a motor chamber is formed between the first housing and the second housing within the housing. The motor chamber communicates with an outside of the housing through the through hole. In other words, the motor chamber is not a space sealed against the outside of the housing.

The compression mechanism is specifically a scroll type compression mechanism, and includes a fixed scroll and an orbiting scroll. The fixed scroll is fixed to the first housing and located opposite to the second housing across the first housing in the axial direction of the electric compressor. The orbiting scroll is disposed in the first housing. The orbiting scroll faces the fixed scroll in the axial direction and is engaged with the fixed scroll.

The electric motor is disposed in the motor chamber. The electric motor includes a stator that is formed in a cylindrical shape and a rotor that is rotatable inside the stator. The stator is fixed to the first end surface of the first housing by a second fastener. Here, the second fastener is fixed in the second hole.

The driving shaft is fixed to the rotor. The driving shaft is rotatably supported by the first housing and the second housing in the motor chamber. A bush is also attached to the driving shaft. The driving shaft is connected to the orbiting scroll through a bush. With this configuration, the electric motor drives the orbiting scroll through the driving shaft.

In this electric compressor, the bush is attached to the driving shaft with the driving shaft and the electric motor disposed in the motor chamber. Here, in this electric compressor, it is possible to hold the driving shaft in the motor chamber with a tool, which is inserted into the second housing from the outside of the housing through an insertion hole formed in the second housing. Thus, the bush is easily attached to the driving shaft in this electric compressor.

In order to fix the stator to the first housing by the second fastener in this type of electric compressor, a fixing portion that is in contact with the stator and to which the second fastener is fixed together with the stator need be formed in the first housing. Here, when the fixing portion is formed in the first housing so as to protrude from the first housing to the stator in a radial direction of the first housing, a stress when the stator is fixed to the fixing portion is easily concentrated on the fixing portion, which causes a concern about durability of the fixing portion. In a case where such a fixing portion is used, the fixing portion need be increased in size to ensure enough stiffness for tolerating the stress. This causes the first housing, and by extension, the housing, to be increased in size, which is problematic.

Also, in this type of electric compressor, the first housing and the second housing cooperate to form a suction chamber into which refrigerant is sucked, and an electric motor is disposed in this suction chamber. In this regard, in the conventional electric compressor described above, the motor chamber communicates with the outside of the housing through the through hole formed in the second housing. With this configuration, the motor chamber is unusable as the suction chamber in this electric compressor. Accordingly, it is required to prevent the refrigerant in the suction chamber from leaking to the outside of the suction chamber while the stator is fixed to the first housing as described above.

The present disclosure has been made in view of the above conventional circumstances, and is directed to providing an electric compressor in which a stator is fixed to a first housing, a housing is decreased in size, and refrigerant is prevented from leaking from a suction chamber to the outside the housing.

### SUMMARY

In accordance with an aspect of the present disclosure, there is provided an electric compressor that includes a housing, a driving shaft, an electric motor that rotates the driving shaft, and a compression mechanism that is driven with rotation of the driving shaft to compress refrigerant. The housing includes a first housing extending in an axial direction of the driving shaft and a second housing fixed to the first housing in the axial direction. The electric motor includes a stator formed in a cylindrical shape and a rotor that is rotatable inside the stator. The first housing and the second housing cooperate to form a suction chamber that is divided from an outside of the housing and into which the refrigerant is sucked. The first housing has a first end surface facing the second housing in the axial direction. The second housing has a second end surface facing the first end surface in the axial direction. A sealing member is provided between the first end surface and the second end surface and seals the suction chamber against the outside of the housing. The first housing and the second housing are fixed with each other by a first fastener. The stator is disposed in the suction chamber and fixed to the first end surface by a second fastener in the axial direction. The first end surface has a first hole which the first fastener is inserted through or fixed in and a second hole in which the second fastener is fixed.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of an electric compressor according to a first embodiment;

FIG. 2 is a perspective view of a first housing in the electric compressor according to the first embodiment;

FIG. 3 is a perspective view illustrating a state in which a stator is fixed to a first end surface in the electric compressor according to the first embodiment;

FIG. 4 is a cross-sectional view of an electric compressor according to a second embodiment;

FIG. 5 is a front view of a first housing in the electric compressor according to the second embodiment;

FIG. 6 is an enlarged cross-sectional view illustrating a main part including a cover and a sleeve in the electric compressor according to the second embodiment;

FIG. 7 is an enlarged perspective view illustrating a main part of a stator core, the cover, and a second fastener in the electric compressor according to the second embodiment; and

FIG. 8 is a cross-sectional view taken along a line A-A of FIG. 4 in the electric compressor according to the second embodiment.

### DETAILED DESCRIPTION OF THE EMBODIMENTS

The following will describe a first embodiment and a second embodiment according to the present disclosure with reference to the drawings. Electric compressors (hereinafter, simply called compressors) in the first embodiment and the second embodiment are specifically scroll type electric compressors. These compressors are each mounted on a vehicle, which is not illustrated, and serve as a part of a vehicle air conditioner. The vehicle is an example of a “mounting object” in the present disclosure.

### First Embodiment

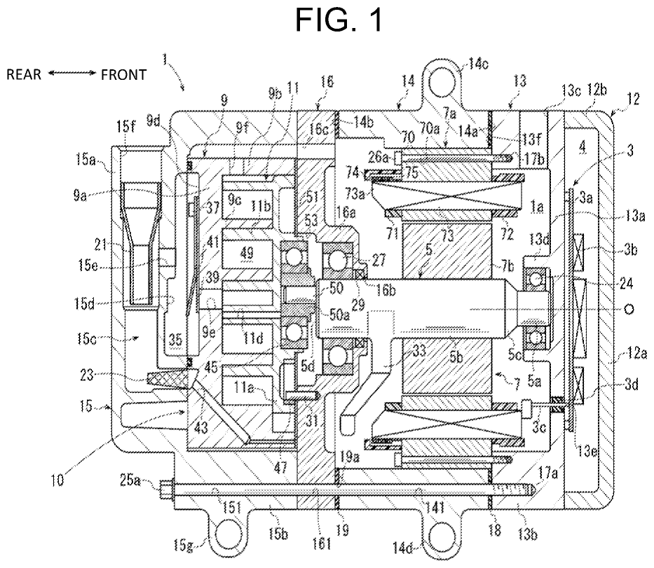

As illustrated in FIG. 1, the compressor in the first embodiment includes a housing 1, an inverter 3, a driving shaft 5, an electric motor 7, and a compression mechanism 10.

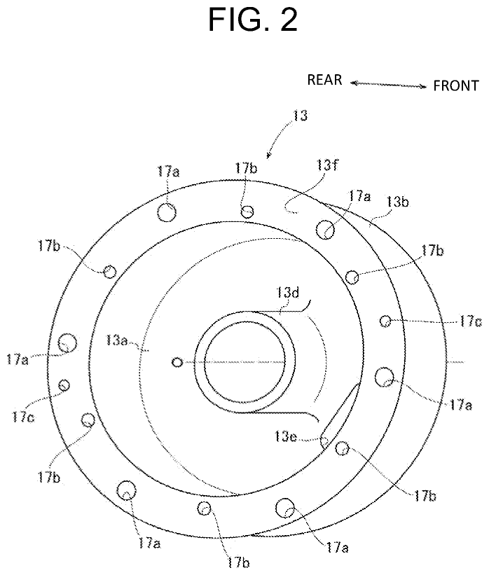

In the present embodiment, a front and rear direction of the compressor is defined by a two-headed solid arrow illustrated in FIG. 1. The front and rear direction is an example of an “axial direction” in the present disclosure. In FIG. 2 and the subsequent drawings, the front and rear direction of the compressor is defined in correspondence with FIG. 1. The front and rear direction is an example for ease of explanation, and a posture of the compressor is changed as appropriate in correspondence with a vehicle on which the compressor is mounted.

As illustrated in FIG. 1, the housing 1 is formed of a first housing 13, a second housing 14, a third housing 15, a fixed block 16, and an inverter housing 12.

As illustrated in FIGS. 1 and 2, the first housing 13 has a front wall 13a and a peripheral wall 13b. The front wall 13a is located at a front end of the first housing 13 and extends in a radial direction of the first housing 13. Note that a “radial direction” is a direction perpendicular to the front and rear direction of the compressor, that is, a direction perpendicular to the axial direction.

The peripheral wall 13b is formed in a cylindrical shape extending around a driving axis O as the center axis. The peripheral wall 13b is connected to the front wall 13a and extends rearward from the front wall 13a. The front wall 13a and the peripheral wall 13b form the first housing 13, which has a bottomed cylindrical shape that is open in a rear direction of the compressor. The driving axis O is parallel with the front and rear direction of the compressor.

The first housing 13 includes a suction connection port 13c, a supporting portion 13d, and a communication port 13e. As illustrated in FIG. 1, the suction connection port 13c is formed in the peripheral wall 13b. The suction connection port 13c extends through the peripheral wall 13b in the radial direction of the compressor. A pipe, which is not illustrated, is connected to the suction connection port 13c.

As illustrated in FIGS. 1 and 2, the supporting portion 13d and the communication port 13e are formed in the front wall 13a. The supporting portion 13d is formed in a cylindrical shape extending around the driving axis O as the center axis and protrudes rearward from the front wall 13a. As illustrated in FIG. 1, a first radial bearing 24 is provided inside the supporting portion 13d. The communication port 13e is located on an outer side of the supporting portion 13d in the radial direction of the compressor, and extends through the front wall 13a in the front and rear direction. Note that an illustration of the first radial bearing 24 is omitted for ease of explanation in FIG. 2.

The first housing 13 also has a first end surface 13f. The first end surface 13f is a rear end surface of the peripheral wall 13b. Accordingly, the first end surface 13f is located at a rear end of the first housing 13.

As illustrated in FIG. 2, six first fixing holes 17a, six second fixing holes 17b, and two positioning holes 17c are formed in the first end surface 13f. Each of the first fixing holes 17a is an example of a “first hole” in the present disclosure. Each of the second fixing holes 17b is an example of a “second hole” in the present disclosure.

The first fixing holes 17a are arranged at regular intervals in a circumferential direction of the first housing 13, are open in the first end surface 13f, and extend into the peripheral wall 13b. The second fixing holes 17b are arranged at regular intervals in the circumferential direction of the first housing 13, are open in the first end surface 13f, and extend into the peripheral wall 13b. The second fixing holes 17b are located on an inner side of the first fixing holes 17a in the radial direction of the compressor. A diameter of each of the second fixing holes 17b is smaller than that of each of the first fixing holes 17a. The number and the size of the first fixing holes 17a and the number and the size of the second fixing holes 17b may be designed as appropriate.

Housing fixing bolts 25a illustrated in FIG. 1 are fixed in the first fixing holes 17a. On the other hand, stator fixing bolts 26a are fixed in the respective second fixing holes 17b. That is, thread grooves, which are not illustrated, are formed in the first fixing holes 17a, and the housing fixing bolts 25a are screwed into the first fixing holes 17a to be engaged with the thread grooves. Thread grooves, which are not illustrated, are also formed in the second fixing holes 17b, and the stator fixing bolts 26a are screwed into the second fixing holes 17b to be engaged with the thread grooves. Each of the housing fixing bolts 25a is an example of a “first fastener” in the present disclosure, and each of the stator fixing bolts 26a is an example of a “second fastener” in the present disclosure.

The positioning holes 17c are arranged at regular intervals in the circumferential direction of the first housing 13, are open in the first end surface 13f, and extend into the peripheral wall 13b. Positioning pins, which are not illustrated, are inserted into the respective positioning holes 17c, and position the first housing 13 relative to the second housing 14. The arrangement and the size of the positioning holes 17c may be designed as appropriate. Instead of forming the positioning holes 17c, a plurality of positioning pins that protrude rearward from the first end surface 13f may be formed.

The first fixing holes 17a, the second fixing holes 17b, and the positioning holes 17c are each shifted in the circumferential direction of the first housing 13 in the first end surface 13f. The first end surface 13f is formed flat except for portions where the first fixing holes 17a, the second fixing holes 17b, and the positioning holes 17c are formed.

As illustrated in FIG. 1, the second housing 14 is disposed at a rear of the first housing 13. The second housing 14 has a cylindrical shape extending in the front and rear direction of the compressor around the driving axis O as the center axis. A peripheral wall of the second housing 14 is thinner than the peripheral wall 13b of the first housing 13.

The second housing 14 has a second end surface 14a and a third end surface 14b. The second end surface 14a is located at a front end of the second housing 14. On the other hand, the third end surface 14b is located at a rear end of the second housing 14.

Six bolt insertion holes 141 are formed in the second housing 14. Although detailed illustrations are omitted, the bolt insertion holes 141 are arranged at regular intervals in a circumferential direction of the second housing 14 so as to correspond to the respective first fixing holes 17a. The bolt insertion holes 141 extend through the second housing 14 in the front and rear direction of the compressor. Accordingly, the bolt insertion holes 141 on a front side thereof are open in the second end surface 14a, and the bolt insertion holes 141 on a rear side thereof are open in the third end surface 14b. The housing fixing bolts 25a are inserted through the respective bolt insertion holes 141. That is, unlike the first fixing holes 17a, the housing fixing bolts 25a are not fixed in the bolt insertion holes 141. Although not illustrated, two positioning pins that protrude forward are fixed to the second end surface 14a. Note that one of the bolt insertion holes 141 is illustrated in FIG. 1. The same goes for bolt insertion holes 151, 161 described later.

The second housing 14 also has an attachment leg 14c and an attachment leg 14d. The attachment legs 14c, 14d protrude from an outer peripheral surface of the second housing 14 toward an outside of the second housing 14 in a radial direction of the second housing 14.

Here, the attachment legs 14c, 14d are disposed between the second end surface 14a and the third end surface 14b in the front and rear direction of the compressor. In other words, the attachment legs 14c, 14d are disposed away from the second end surface 14a in the rear direction of the compressor and away from the third end surface 14b in the front direction of the compressor. Note that the second housing 14 may have either the attachment leg 14c or the attachment leg 14d or may have another attachment leg in addition to the attachment legs 14c, 14d.

The third housing 15 has a rear wall 15a, a peripheral wall 15b, and an attachment leg 15g. The rear wall 15a is located at a rear end of the third housing 15, and extends in a radial direction of the third housing 15. The peripheral wall 15b is connected to the rear wall 15a and extends forward from the rear wall 15a. The rear wall 15a and the peripheral wall 15b form the third housing 15, which has a bottomed cylindrical shape that is open in the front direction of the compressor.

The attachment leg 15g protrudes from an outer peripheral surface of the peripheral wall 15b toward an outside of the third housing 15 in the radial direction of the third housing 15. Note that the attachment leg 15g may be omitted in the third housing 15.

An oil separation chamber 15c, a first discharge recess 15d, a discharge passage 15e, and a discharge connection port 15f are formed in the third housing 15. The oil separation chamber 15c is located on a rear side of the third housing 15 therein and extends in the radial direction of the third housing 15. The first discharge recess 15d is located in front of the oil separation chamber 15c in the third housing 15, and recessed toward the oil separation chamber 15c. The discharge passage 15e extends in the front and rear direction of the compressor, and the oil separation chamber 15c communicates with the first discharge recess 15d through the discharge passage 15e. The discharge connection port 15f communicates with an upper end of the oil separation chamber 15c and opens toward the outside of the third housing 15. The discharge connection port 15f is connected to a pipe, which is not illustrated.

An oil separation cylinder 21 is fixed in the oil separation chamber 15c. An inner peripheral surface of the oil separation chamber 15c and an outer peripheral surface of the oil separation cylinder 21 cooperate to form a separator. A filter 23 is provided under the oil separation cylinder 21 in the oil separation chamber 15c.

The six bolt insertion holes 151 are formed in the peripheral wall 15b. Although detailed illustrations are omitted, the bolt insertion holes 151 are arranged at regular intervals in a circumferential direction of the third housing 15 so as to correspond to the respective bolt insertion holes 141 of the second housing 14. The bolt insertion holes 151 extend through the peripheral wall 15b in the front and rear direction of the compressor.

The fixed block 16 is disposed between the second housing 14 and the third housing 15. The fixed block 16 has a boss 16a protruding forward. An insertion hole 16b is formed at an end of the boss 16a. A second radial bearing 27 and a shaft sealing member 29 are provided inside the boss 16a.

In addition, a suction passage 16c and the six bolt insertion holes 161 are formed in the fixed block 16. The suction passage 16c is located on an outer side of the boss 16a in a radial direction of the fixed block 16. The suction passage 16c extends through the fixed block 16 in the front and rear direction of the compressor.

The bolt insertion holes 161 are also located on the outer side of the boss 16a in the radial direction of the fixed block 16. Although detailed illustrations are omitted, the bolt insertion holes 161 are arranged at regular intervals in a circumferential direction of the fixed block 16 so as to correspond to the respective bolt insertion holes 141 of the second housing 14 and the respective bolt insertion holes 151 of the third housing 15. The bolt insertion holes 161 extend through the fixed block 16 in the front and rear direction of the compressor.

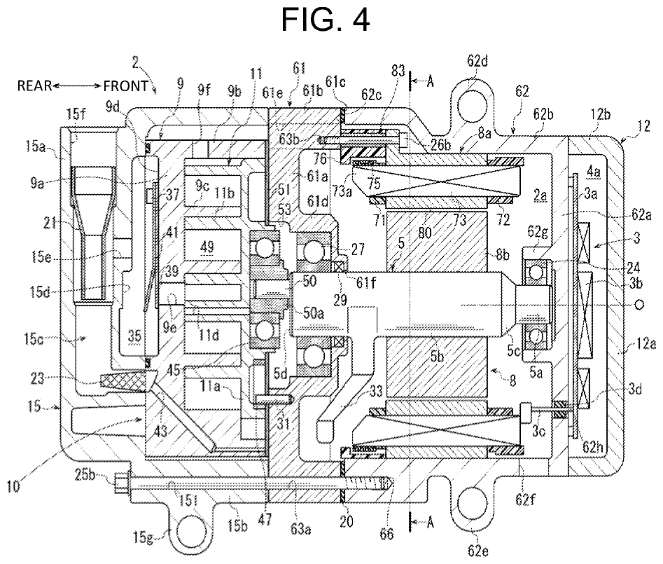

In addition, a plurality of anti-rotation pins 31 that protrude rearward are fixed in the fixed block 16. Note that one of the plurality of anti-rotation pins 31 and one of a plurality of rings 47 described later are illustrated in FIG. 1. The same goes for FIG. 4.

As illustrated in FIG. 1, the inverter housing 12 is disposed at a front of the first housing 13. The inverter housing 12 has a front wall 12a and a peripheral wall 12b. The front wall 12a is located at a front end of the inverter housing 12 and extends in a radial direction of the inverter housing 12. The peripheral wall 12b has a cylindrical shape extending in the front and rear direction of the compressor around the driving axis O as the center axis. The peripheral wall 12b is connected to the front wall 12a and extends rearward from the front wall 12a. The front wall 12a and the peripheral wall 12b form the inverter housing 12, which has a bottomed cylindrical shape that is open in the rear direction of the compressor. The inverter housing 12 also has a connector, which is not illustrated.

The inverter housing 12 is fixed to the first housing 13 by bolts, which are not illustrated, with a rear end of the peripheral wall 12b of the inverter housing 12 being in contact with the front wall 13a of the first housing 13. Thus, the inverter housing 12 and the first housing 13 are fixed with each other in the front and rear direction of the compressor.

When the inverter housing 12 and the first housing 13 are fixed with each other, an inverter chamber 4 is formed inside the peripheral wall 12b of the inverter housing 12 and between the front wall 13a of the first housing 13 and the front wall 12a of the inverter housing 12.

In the housing 1, a gasket 18 is provided between the first end surface 13f of the first housing 13 and the second end surface 14a of the second housing 14. The gasket 18 is an example of a “sealing member” in the present disclosure. Although detailed illustrations are omitted, the gasket 18 is formed of a plate-shaped core material made of metal and resin layers provided on opposite sides of the core material. Thus, the gasket 18 is formed in a plate shape. Note that the gasket 18 may be formed of only a plate-shaped resin material, for example.

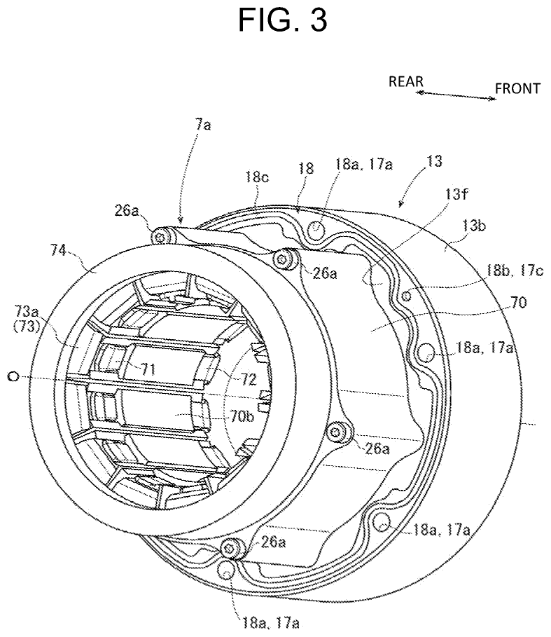

As illustrated in FIG. 3, the gasket 18 is formed in a substantially annular shape. More specifically, the gasket 18 is formed such that the gasket 18 keeps away from the second fixing holes 17b and portions near the second fixing holes 17b in the first end surface 13f on an outer side thereof in the radial direction of the compressor when the gasket 18 is disposed between the first end surface 13f of the first housing 13 and the second end surface 14a of the second housing 14. That is, the gasket 18 is formed in the substantially annular shape enclosing the whole of the second fixing holes 17b in the radial direction of the first housing 13, while the gasket 18 is located on the outer side of the second fixing holes 17b formed in the first end surface 13f when the gasket 18 is disposed between the first end surface 13f of the first housing 13 and the second end surface 14a of the second housing 14. Thus, the gasket 18 is formed such that the gasket 18 does not overlap the second fixing holes 17b and the portions near the second fixing holes 17b in the first end surface 13f in the front and rear direction of the compressor.

Six first through holes 18a, two second through holes 18b, and ribs 18c are formed in the gasket 18. The first through holes 18a and the second through holes 18b extend through the gasket 18 in the front and rear direction of the compressor. The first through holes 18a are disposed at portions of the gasket 18 in correspondence with the first fixing holes 17a of the first housing 13. On the other hand, the second through holes 18b are disposed at portions of the gasket 18 in correspondence with the positioning holes 17c of the first housing 13.

The ribs 18c are formed on opposite sides of the gasket 18, and protrude in a front direction and a rear direction of the gasket 18, respectively. The ribs 18c are located inside the first through holes 18a and the second through holes 18b in the radial direction of the gasket 18, and make one round on the gasket 18 in a circumferential direction thereof.

As illustrated in FIG. 1, in the housing 1, a gasket 19 is provided between the third end surface 14b of the second housing 14 and the fixed block 16. Similarly to the gasket 18, the gasket 19 is formed in a plate shape. Six through holes 19a are formed in the gasket 19 in correspondence with the bolt insertion holes 141, 161. Although not illustrated, a gasket is also provided between the third housing 15 and the fixed block 16.

In the housing 1, the first, second, and third housings 13, 14, 15, the fixed block 16, and the gaskets 18, 19 are fixed by the six housing fixing bolts 25a. Here, when the first, second, and third housings 13, 14, 15, the fixed block 16, and the gaskets 18, 19 are fixed with each other, firstly, the first housing 13, the second housing 14, the fixed block 16, and the third housing 15 are arranged in this order from a front side of the compressor toward a rear side of the compressor. In addition, the gasket 18 is disposed between the first end surface 13f of the first housing 13 and the second end surface 14a of the second housing 14, and the gasket 19 is disposed between the third end surface 14b of the second housing 14 and the fixed block 16. At this time, the first through holes 18a and the second through holes 18b of the gasket 18 get aligned with the first fixing holes 17a and the positioning holes 17c of the first end surface 13f, respectively. Similarly, in the gasket 19, the through holes 19a get aligned with the bolt insertion holes 141 of the second end surface 14a.

Then, in the second housing 14, the positioning pins provided on the second end surface 14a are inserted into the positioning holes 17c. With this operation, the first housing 13 is positioned relative to the second housing 14, so that the first fixing holes 17a, the first through holes 18a, and the bolt insertion holes 141 get aligned with each other in the front and rear direction of the compressor. Similarly to the first housing 13 and the second housing 14, the third housing 15, the fixed block 16, and the second housing 14 are positioned relative to each other, so that the bolt insertion holes 151, the bolt insertion holes 161, the through holes 19a, and the bolt insertion holes 141 get aligned with each other in the front and rear direction of the compressor.

Then, in this state, the housing fixing bolts 25a are inserted into the bolt insertion holes 151 from the third housing 15 toward the first housing 13. Accordingly, the housing fixing bolts 25a are inserted into the bolt insertion holes 151, the bolt insertion holes 161, the through holes 19a, the bolt insertion holes 141, and the first through holes 18a in this order. Then, the housing fixing bolts 25a are fixed in the first fixing holes 17a by screwing the housing fixing bolts 25a into the first fixing holes 17a formed in the first end surface 13f. Thus, the first, second, and third housings 13, 14, 15, the fixed block 16, and the first and second gaskets 18, 19 are fixed with each other in the front and rear direction of the compressor. As described above, the inverter housing 12 is fixed to the first housing 13. That is, in the housing 1, the inverter housing 12, the first housing 13, the second housing 14, the fixed block 16, and the third housing 15 are fixed in this order from the front side of the compressor toward the rear side of the compressor.

In the housing 1, the first end surface 13f of the first housing 13 faces the second end surface 14a of the second housing 14 through the gasket 18 in the front and rear direction of the compressor. Similarly to the first housing 13 and the second housing 14, the third end surface 14b of the second housing 14 faces the fixed block 16 through the gasket 19 in the front and rear direction of the compressor and the front end of the peripheral wall 15b of the third housing 15 faces the fixed block 16 through the gasket in the front and rear direction of the compressor through the gasket.

In the housing 1, the first housing 13, the second housing 14, and the fixed block 16 cooperate to form a suction chamber 1a. The suction chamber 1a is defined by the first housing 13, the second housing 14, the fixed block 16, and the first and second gaskets 18, 19 and divided from the outside of the housing 1. Here, the gasket 18 seals the suction chamber 1a against the outside of the housing 1. The suction chamber 1a communicates with the suction connection port 13c. With this configuration, refrigerant is suctioned from the outside of the housing 1 into the suction chamber 1a through the pipe connected to the suction connection port 13c. The suction chamber 1a also communicates with the suction passage 16c.

The inverter 3 is accommodated in the inverter chamber 4. The inverter 3 is formed of a circuit board 3a, switching elements 3b mounted on the circuit board 3a, and the like. In the inverter 3, the circuit board 3a is fixed to the front wall 13a of the first housing 13 by bolts, which are not illustrated. The inverter 3 is electrically connected to a battery, which is not illustrated, for the vehicle through the connector provided in the inverter housing 12.

The driving shaft 5 is disposed in the suction chamber 1a. The driving shaft 5 is formed in a columnar shape extending in the front and rear direction of the compressor. The driving shaft 5 includes a small diameter portion 5a, a large diameter portion 5b, and a tapered portion 5c. The small diameter portion 5a is located on a front side of the driving shaft 5. The large diameter portion 5b is located behind the small diameter portion 5a. A diameter of the large diameter portion 5b is larger than that of the small diameter portion 5a. A rear end surface 5d being flat is located at a rear end of the large diameter portion 5b. The tapered portion 5c is located between the small diameter portion 5a and the large diameter portion 5b. A front end of the tapered portion 5c is connected to the small diameter portion 5a. The tapered portion 5c increases in diameter as the tapered portion 5c extends rearward, and a rear end of the tapered portion 5c is connected to the large diameter portion 5b.

The small diameter portion 5a of the driving shaft 5 is rotatably supported by the supporting portion 13d of the first housing 13 through the first radial bearing 24. A rear end portion of the large diameter portion 5b is inserted into the insertion hole 16b of the fixed block 16 and enters the boss 16a. In the boss 16a, the rear end portion of the large diameter portion 5b is rotatably supported by the second radial bearing 27. As a result, the driving shaft 5 is rotatable around the driving axis O in the housing 1. A space between the boss 16a and the driving shaft 5 is sealed by the shaft sealing member 29.

In the driving shaft 5, an eccentric pin 50 is fixed to the large diameter portion 5b. The eccentric pin 50 is disposed at a position eccentric to the driving axis O in the rear end surface 5d. The eccentric pin 50 is formed in a columnar shape with a diameter smaller than that of the driving shaft 5, and extends rearward from the rear end surface 5d. When the large diameter portion 5b of the driving shaft 5 is inserted into the insertion hole 16b, the eccentric pin 50 enters the boss 16a. The eccentric pin 50 is engaged with a bush 50a in the boss 16a.

A balance weight 33 is formed integrally with the large diameter portion 5b of the driving shaft 5. The balance weight 33 is disposed at a position eccentric to the driving axis O in the large diameter portion 5b. More specifically, the balance weight 33 is disposed at a position distant from the eccentric pin 50 across the driving axis O.

Although detailed illustrations are omitted, the balance weight 33 is formed in a substantially fan-shaped plate shape. The balance weight 33 extends in a radial direction of the driving shaft 5 from the large diameter portion 5b toward the second housing 14. When the driving shaft 5 is disposed in the housing 1, the balance weight 33 is located in the suction chamber 1a. More specifically, the balance weight 33 is located between the fixed block 16 and the electric motor 7 in the suction chamber 1a. Note that a shape of the balance weight 33 may be designed as appropriate.

The electric motor 7 is formed of a stator 7a and a rotor 7b. As illustrated in FIG. 3, the stator 7a includes a stator core 70, a first insulator 71, a second insulator 72, a plurality of coils 73, and a cover 74.

The stator core 70 is made of metal. As illustrated in FIG. 1, the stator core 70 is formed in a substantially cylindrical shape extending in the front and rear direction of the compressor around the driving axis O as the center axis. Six insertion holes 70a are formed in the stator core 70. The insertion holes 70a are arranged at regular intervals in a circumferential direction of the stator core 70 so as to correspond to the respective second fixing holes 17b formed in the first end surface 13f of the first housing 13. The insertion holes 70a extend through the stator core 70 in the front and rear direction of the compressor. Here, as illustrated in FIG. 3, portions in the stator core 70 where the insertion holes 70a are formed protrude more outwardly in a radial direction of the stator core 70 than the other portions in the stator core 70. That is, the insertion holes 70a are located on an outer side of the cover 74 in the radial direction of the stator core 70. In the stator core 70, teeth 70b are formed on an inner side of the insertion holes 70a in the radial direction of the stator core 70.

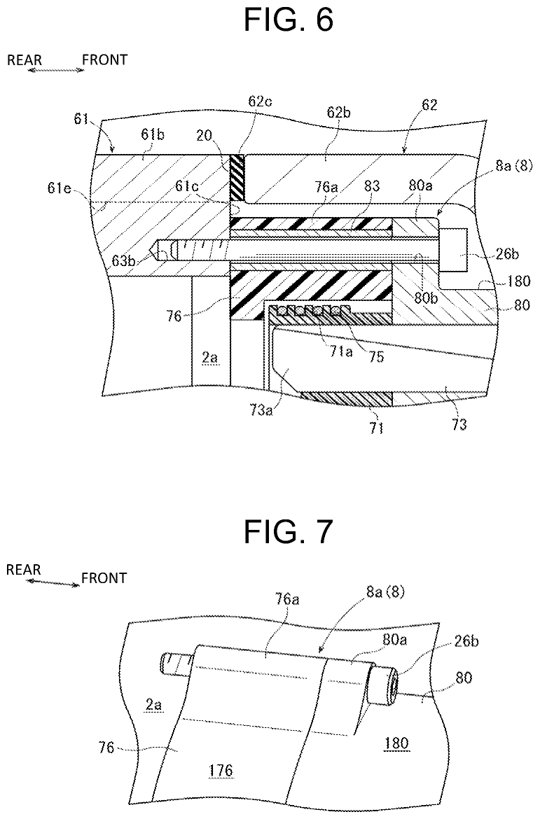

The first insulator 71 and the second insulator 72 are made of resin such as PPS (polyphenylene sulfide), and have an electrical insulation property and heat resistance against heat generated from the coils 73. As illustrated in FIG. 1, the first insulator 71 is disposed away from the second insulator 72 in the front and rear direction of the compressor with the stator core 70 interposed between the first insulator 71 and the second insulator 72. That is, the first insulator 71 is disposed at a rear end of the stator core 70, and the second insulator 72 is disposed at a front end of the stator core 70. Although not illustrated, a plurality of first slots are formed in the first insulator 71, and a plurality of second slots are formed in the second insulator 72. In addition, guide portions 71a that guide conductor wires 75 are formed in the first insulator 71 (see FIG. 6). The first and second insulators 71, 72 may be made of other materials having an electrical insulation property and heat resistance.

The coils 73 are made of the conductor wires 75 wound around first slots of the first insulator 71, the teeth 70b of the stator core 70, and second slots of the second insulator 72. Each of the coils 73 has coil ends 73a. The coil ends 73a are specifically portions that protrude from the stator core 70 in the front and rear direction of the compressor in each of the coils 73. Here, inner peripheral portions of the coil ends 73a on a rear side thereof are inclined to avoid interference with the balance weight 33.

Similarly to the first and second insulators 71, 72, the cover 74 is made of resin, and has the electrical insulation property and the heat resistance. As illustrated in FIG. 3, the cover 74 is formed in a substantially cylindrical shape. The cover 74 is attached to the rear end of the stator core 70, and covers rear ends of the first insulator 71 and the coil ends 73a on the rear side thereof in the radial direction of the compressor.

As illustrated in FIG. 1, the rotor 7b is rotatably disposed inside the stator 7a. The large diameter portion 5b of the driving shaft 5 is fixed in the rotor 7b by shrink fitting. Thus, the rotor 7b and the driving shaft 5 are integrally formed with each other. The rotor 7b rotates inside the stator 7a to rotate the driving shaft 5 around the driving axis O.

As illustrated in FIGS. 1 and 3, in this compressor, the stator core 70, and by extension, the stator 7a, is fixed to the first end surface 13f of the first housing 13. When the stator core 70 is fixed to the first end surface 13f, the second fixing holes 17b in the first end surface 13f and the insertion holes 70a of the stator core 70 get aligned with each other in the front and rear direction of the compressor. In this state, the stator fixing bolts 26a are inserted into the respective insertion holes 70a from the rear end of the stator core 70 toward the first housing 13. Then, the stator fixing bolts 26a are fixed in the second fixing holes 17b by screwing the stator fixing bolts 26a into the second fixing holes 17b. Accordingly, the stator core 70 is fixed to the first end surface 13f. Here, as described above, the insertion holes 70a of the stator core 70 are located on the outer side of the cover 74 in the radial direction of the compressor in the stator core 70, and thus, the stator core 70 is fixed to the first end surface 13f by the stator fixing bolts 26a at a position on the outer side of the cover 74 in the radial direction of the compressor. Thus, in this compressor, the stator 7a and the rotor 7b, that is, the electric motor 7, is disposed in the suction chamber 1a. This means that in this compressor, the suction chamber 1a also serves as a motor chamber that accommodates the electric motor 7.

As illustrated in FIG. 2, in the first end surface 13f, the second fixing holes 17b are disposed on the inner side of the first fixing holes 17a in the radial direction of the first housing 13. Accordingly, the stator core 70 is fixed to the first end surface 13f, and by extension, to the first housing 13, by the stator fixing bolts 26a on an inner side of the housing fixing bolts 25a in the radial direction of the first housing 13.

As described above, the gasket 18 is formed such that the gasket 18 keeps away from the second fixing holes 17b and the portions near the second fixing holes 17b in the first end surface 13f on the outer side thereof in the radial direction of the compressor. Accordingly, the stator core 70 is fixed to first end surface 13f by the stator fixing bolts 26a with the front end of the stator core 70 being directly in contact with the first end surface 13f.

As illustrated in FIG. 1, each of the coils 73 of the stator 7a is connected to a connection terminal 3c in the suction chamber 1a. The connection terminal 3c is connected to the inverter 3 in the inverter chamber 4 while being inserted through the communication port 13e. Here, a space between the communication port 13e and the connection terminal 3c is sealed by a hermetically sealing member 3d. Thus, the stator 7a and the inverter 3 are electrically connected.

The compression mechanism 10 is specifically a scroll type compression mechanism, and includes a fixed scroll 9 and a movable scroll 11. The fixed scroll 9 is fixed to the third housing 15 and disposed in the third housing 15. The fixed scroll 9 has a fixed scroll base plate 9a, a fixed scroll peripheral wall 9b, and a fixed scroll spiral wall 9c. The fixed scroll base plate 9a is located at a rear end of the fixed scroll 9 and formed in a disc shape. A second discharge recess 9d and a discharge port 9e are formed in the fixed scroll base plate 9a. The second discharge recess 9d is recessed from a rear end surface of the fixed scroll base plate 9a in the front direction of the compressor. When the fixed scroll 9 is fixed to the third housing 15, the second discharge recess 9d faces the first discharge recess 15d. Thus, the first discharge recess 15d and the second discharge recess 9d cooperate to form a discharge chamber 35. The discharge chamber 35 communicates with the oil separation chamber 15c through the discharge passage 15e. The discharge port 9e extends through the fixed scroll base plate 9a in the front and rear direction of the compressor, and communicates with the discharge chamber 35.

A discharge reed valve 39 and a retainer 41 are attached to the fixed scroll base plate 9a by a fixing bolt 37. The fixing bolt 37, the discharge reed valve 39, and the retainer 41 are disposed in the discharge chamber 35. The discharge reed valve 39 is elastically deformed to open and close the discharge port 9e. The retainer 41 adjusts an amount of the elastic deformation of the discharge reed valve 39.

The fixed scroll peripheral wall 9b is connected to the fixed scroll base plate 9a at an outer periphery of the fixed scroll base plate 9a, and is formed in a cylindrical shape extending forward. A suction port 9f is formed in the fixed scroll peripheral wall 9b. The suction port 9f extends through the fixed scroll peripheral wall 9b in a radial direction of the fixed scroll 9. Accordingly, the suction port 9f opens in the third housing 15. The fixed scroll spiral wall 9c is provided upright from a front surface of the fixed scroll base plate 9a, and is formed integrally with the fixed scroll peripheral wall 9b inside the fixed scroll peripheral wall 9b.

An oil supply passage 43 is also formed in the fixed scroll 9. The oil supply passage 43 extends through the fixed scroll base plate 9a and the fixed scroll peripheral wall 9b. With this configuration, the oil supply passage 43 at a rear end thereof opens in the rear end surface of the fixed scroll base plate 9a, and the oil supply passage 43 at a front end thereof opens in a front end surface of the fixed scroll peripheral wall 9b. The oil supply passage 43 communicates with the oil separation chamber 15c through the filter 23. Note that a shape of the oil supply passage 43 may be designed as appropriate.

The movable scroll 11 is disposed in the third housing 15 and located between the fixed scroll 9 and the fixed block 16. The movable scroll 11 has a movable scroll base plate 11a and a movable scroll spiral wall 11b. The movable scroll base plate 11a is located at a front end of the movable scroll 11 and formed in a disc shape. The bush 50a is rotatably supported by the movable scroll base plate 11a through a third radial bearing 45. Thus, the movable scroll 11 is connected to the driving shaft 5 at a position eccentric to the driving axis O through the bush 50a and the eccentric pin 50.

The same number of rings 47 as the anti-rotation pins 31 are provided in the movable scroll base plate 11a. End portions of the anti-rotation pins 31 are loosely fitted into the rings 47. The anti-rotation pins 31 and the rings 47 cooperate to form an anti-rotation mechanism.

The movable scroll spiral wall 11b is provided upright from a rear surface of the movable scroll base plate 11a, and extends toward the fixed scroll base plate 9a. An air supply hole 11d is opened at a rear end of the movable scroll spiral wall 11b and located near a center of the movable scroll spiral wall 11b. The air supply hole 11d extends through the movable scroll spiral wall 11b and also through the movable scroll base plate 11a in the front and rear direction of the compressor.

The fixed scroll 9 and the movable scroll 11 are engaged with each other. With this engagement, the fixed scroll base plate 9a, the fixed scroll spiral wall 9c, the movable scroll base plate 11a, and the movable scroll spiral wall 11b cooperate to form a compression chamber 49 between the fixed scroll 9 and the movable scroll 11. The compression chamber 49 changes its volume as the movable scroll 11 rotates. This change causes the compression chamber 49 to communicate with each of the suction port 9f and the discharge port 9e.

A thrust plate 51 is provided between the movable scroll 11 and the fixed block 16. The thrust plate 51 is made of a thin metal plate, and is in contact with the movable scroll 11 and the fixed block 16 on the opposite sides of the thrust plate 51. The thrust plate 51 urges the movable scroll 11 rearward, that is, toward the fixed scroll 9 by a restoring force generated during elastic deformation. The movable scroll base plate 11a and the thrust plate 51 cooperate to form a back-pressure chamber 53 in the boss 16a of the fixed block 16. The back-pressure chamber 53 communicates with the air supply hole 11d.

The compressor configured as described above is attached to the vehicle when the attachment legs 14c, 14d, 15g are fixed to an engine or the like of the vehicle by bolts, which are not illustrated.

Then, in the compressor, the inverter 3 converts direct current supplied from the battery into alternating current by the switching elements 3b, so that power is supplied to the stator 7a. As a result, the electric motor 7 is driven and controlled by the inverter 3, thereby rotating the rotor 7b together with the driving shaft 5 in the stator 7a. Thus, in the compression mechanism 10, when the movable scroll 11 rotates, the movable scroll base plate 11a slides on a tip of the fixed scroll spiral wall 9c, and the fixed scroll spiral wall 9c and the movable scroll spiral wall 11b slide on each other. Here, rotation of the movable scroll 11 is regulated by the anti-rotation mechanism and the movable scroll 11 only rotates relative to the fixed scroll 9.

The refrigerant in the suction chamber 1a is sucked into the compression chamber 49 through the suction passage 16c and the suction port 9f with the rotation of the movable scroll 11. As a volume of the compression chamber 49 is reduced by the rotation of the movable scroll 11, the refrigerant in the compression chamber 49 is compressed. That is, the compression mechanism 10 is driven with the rotation of the driving shaft 5 to compress the refrigerant. The refrigerant with high pressure compressed in the compression chamber 49 is discharged to the discharge chamber 35 through the discharge port 9e, and then, flows from the discharge chamber 35 to the oil separation chamber 15c through the discharge passage 15e. Lubricant oil is separated from the refrigerant with the high pressure while the refrigerant goes back and force between the outer peripheral surface of the oil separation cylinder 21 and the inner peripheral surface of the oil separation chamber 15c. In this state, the refrigerant flows through the oil separation cylinder 21 and is discharged into the outside of the housing 1 through the discharge connection port 15f.

On the other hand, the lubricant oil separated from the refrigerant is stored in the oil separation chamber 15c. Then, this lubricant oil flows through the filter 23 and the oil supply passage 43 and is supplied to a sliding portion between the fixed scroll 9 and the movable scroll 11, an inside of the suction chamber 1a, or the like.

A part of the refrigerant with the high pressure compressed in the compression chamber 49 flows through the air supply hole 11d and is supplied to the back-pressure chamber 53. With this supply, the movable scroll 11 is urged toward the compression chamber 49 by pressure in the back-pressure chamber 53 via the thrust plate 51. The movable scroll 11 is also urged toward the compression chamber 49 by an elastic force of the thrust plate 51. Thus, in this compressor, the movable scroll 11 is prevented from rotating in a state where the movable scroll 11 is inclined relative to the driving axis O.

In this compressor, the stator 7a is fixed to the first end surface 13f by fixing the stator fixing bolts 26a in the second fixing holes 17b formed in the first end surface 13f of the first housing 13. Thus, in this compressor, the first end surface 13f serves as a seat surface for fixing the stator 7a, that is, as a fixing portion for the stator 7a. With this configuration, in this compressor, a fixing portion exclusively for the stator 7a need not be formed in the peripheral wall 13b of the first housing 13 such that the fixing portion partly protrudes into the suction chamber 1a.

That is, in a case where a fixing portion exclusively for the stator 7a is formed in the peripheral wall 13b such that the fixing portion partly protrudes into the suction chamber 1a, stress is easily concentrated at a connection portion between the peripheral wall 13b and the fixing portion when the stator 7a is fixed to such a fixing portion by the stator fixing bolts 26a. In this respect, in this compressor, the stator 7a is fixed to the first end surface 13f by the stator fixing bolts 26a, which suppresses the stress applied to the first end surface 13f when the stator 7a is fixed. Accordingly, in this compressor, it is not required to ensure an area of the first end surface 13f by forming the peripheral wall 13b excessively thick in order to ensure stiffness of the first end surface 13f. As a result, in this compressor, it is suppressed that the first housing 13 is increased in size.

In this compressor, the stator 7a is fixed to the first end surface 13f, and thus, a contact area between the first end surface 13f and the stator core 70 is suitably ensured. Here, in this compressor, the first end surface 13f is directly in contact with the stator core 70, and thus, the stator 7a is firmly fixed to the first end surface 13f by the stator fixing bolts 26a.

In this compressor, the first fixing holes 17a are formed in the first end surface 13f, and the housing fixing bolts 25a are fixed in the first fixing holes 17a. Accordingly, the first end surface 13f also serves as a fixing portion in which the first, second, and third housing 13, 14, 15 and the fixed block 16 are fixed by the housing fixing bolts 25a. This means that the fixing portion exclusively for fixing the housing fixing bolts 25a need not be formed in the first housing 13 in this compressor. Also in this respect, in this compressor, it is suppressed that the first housing 13 is increased in size.

In this compressor, the first housing 13, the second housing 14, and the fixed block 16 cooperate to form the suction chamber 1a in the housing 1. This suction chamber 1a is defined by the first housing 13, the second housing 14, the fixed block 16, and the first and second gaskets 18, 19 and divided from the outside of the housing 1. In other words, the suction chamber 1a is a space sealed against the outside of the housing 1. In addition, the gasket 18 is provided between the first end surface 13f and the second end surface 14a, and the gasket 19 is provided between the third end surface 14b and the fixed block 16. With this configuration, in this compressor, the refrigerant in the suction chamber 1a hardly leaks from a space between the first end surface 13f and the second end surface 14a and a space between the third end surface 14b and the fixed block 16 to the outside of the housing 1.

Therefore, according to the compressor of the first embodiment, the stator 7a is fixed to the first housing 13, the housing 1 is decreased in size, and the refrigerant is prevented from leaking from the suction chamber 1a to the outside of the housing 1.

In this compressor, the inverter housing 12 is fixed at the front of the first housing 13, and thus, the first, second, and third housing 13, 14, 15, the fixed block 16, and the inverter housing 12 are fixed in the front and rear direction of the compressor in the housing 1. With this configuration, in this compressor, it is suppressed that the housing 1, and by extension, the compressor, is increased in size in the radial direction of the compressor as compared to a case where the inverter housing 12 is fixed to the peripheral wall 13b of the first housing 13 or the second housing 14 in the radial direction of the compressor.

In the compressor, the stator core 70 of the stator 7a is fixed to the first end surface 13f by the stator fixing bolts 26a on the outer side of the cover 74, the first and second insulators 71, 72, and the coil ends 73a in the radial direction of the compressor. Accordingly, in this compressor, the stator core 70, and by extension, the stator 7a, is easily fixed to the first end surface 13f by the stator fixing bolts 26a.

### Second Embodiment

A compressor in a second embodiment includes a housing 2 and an electric motor 8, which are illustrated in FIG. 4, instead of the housing 1 and electric motor 7. The housing 2 is formed of a first housing 61, a second housing 62, the third housing 15, and the inverter housing 12.

The first housing 61 has a rear wall 61a and a peripheral wall 61b. The rear wall 61a is located at a rear end of the first housing 61, and extends in a radial direction of the first housing 61. Similarly to the fixed block 16 in the first embodiment, the plurality of anti-rotation pins 31 that protrude rearward are fixed to the rear wall 61a.

The peripheral wall 61b is formed in a cylindrical shape extending around the driving axis O as the center axis. The peripheral wall 61b is connected to the rear wall 61a and extends forward from the rear wall 61a. The rear wall 61a and the peripheral wall 61b form the first housing 61, which has a bottomed cylindrical shape that is open in the front direction of the compressor.

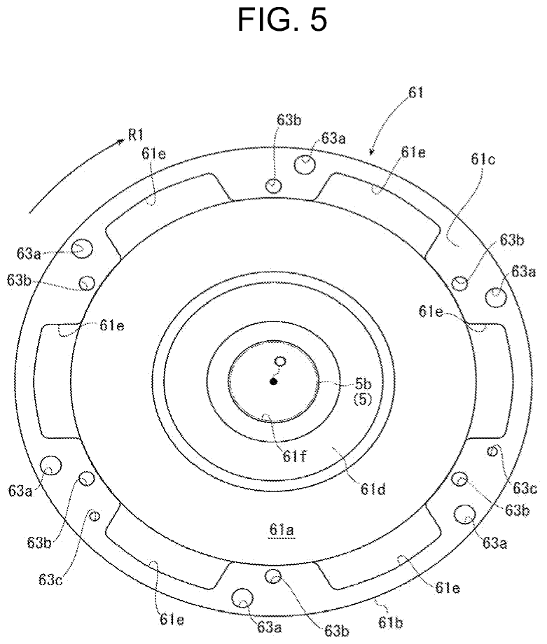

As illustrated in FIG. 5, the first housing 61 has a first end surface 61c. The first end surface 61c is a front end surface of the peripheral wall 61b. That is, the first end surface 61c is located at a front end of the first housing 61.

Six bolt insertion holes 63a, six fixing holes 63b, and two positioning holes 63c are formed in the first end surface 61c. Each of the bolt insertion holes 63a is an example of the “first hole” in the present disclosure. Each of the fixing holes 63b is an example of the “second hole” in the present disclosure.

The bolt insertion holes 63a extend through the first housing 61 in the front and rear direction of the compressor. The bolt insertion holes 63a are arranged at regular intervals in a circumferential direction of the first housing 61. The housing fixing bolts 25b are inserted into the respective bolt insertion holes 63a. Each of the housing fixing bolts 25b is an example of the “first fastener” in the present disclosure.

The fixing holes 63b are arranged at regular intervals in the circumferential direction of the first housing 61, are open in the first end surface 61c, and extend into the peripheral wall 61b. The fixing holes 63b are located on an inner side of the bolt insertion holes 63a in the radial direction of the compressor. Thread grooves, which are not illustrated, are formed in the fixing holes 63b, and stator fixing bolts 26b are screwed into the fixing holes 63b to be engaged with the thread grooves. Each of the stator fixing bolts 26b is an example of the “second fastener” in the present embodiment. A diameter of each of the fixing holes 63b is smaller than that of each of the bolt insertion holes 63a. The number and the size of the bolt insertion holes 63a and the number and the size of the fixing holes 63b may be designed as appropriate.

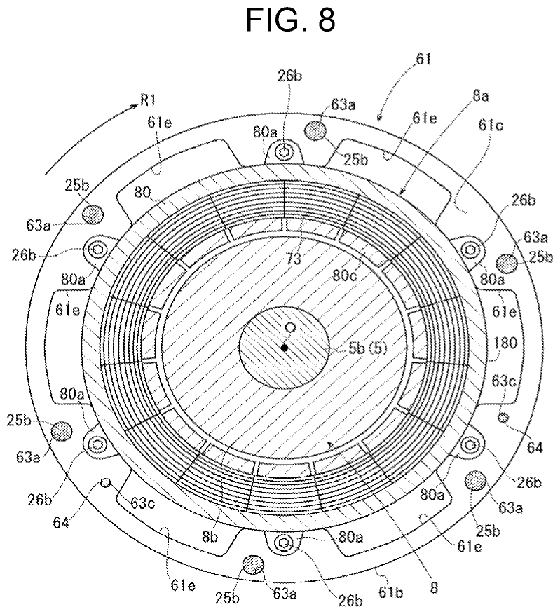

The positioning holes 63c are arranged at regular intervals in the circumferential direction of the first housing 61, are open in the first end surface 61c, and extend into the peripheral wall 61b. Positioning pins 64 illustrated in FIG. 8 are inserted into the respective positioning holes 63c. Here, as illustrated in FIGS. 5 and 8, the bolt insertion holes 63a, the fixing holes 63b, and the positioning holes 63c are each shifted in the circumferential direction of the first housing 61. The arrangement and the size of the positioning holes 63c may be designed as appropriate. Instead of forming the positioning holes 63c, the plurality of positioning pins 64 that protrude forward may be fixed to the first end surface 61c.

As illustrated in FIGS. 4 and 5, a boss 61d and six suction passages 61e are formed in the first housing 61. The boss 61d is formed in a cylindrical shape extending around the driving axis O as the center axis and protrudes forward from the rear wall 61a. An insertion hole 61f is formed at an end of the boss 61d. As illustrated in FIG. 4, the second radial bearing 27 and the shaft sealing member 29 are provided inside the boss 61d, similarly to the compressor in the first embodiment.

As illustrated in FIG. 5, the suction passages 61e are each formed in a long hole shape extending in the circumferential direction of the first housing 61. The suction passages 61e extend through the first housing 61 in the front and rear direction of the compressor. The suction passages 61e are arranged at regular intervals in the circumferential direction of the first housing 61. Note that the shape and the number of the suction passages 61e may be designed as appropriate.

In the first housing 61, the suction passages 61e are each shifted relative to the bolt insertion holes 63a, the fixing holes 63b, and the positioning holes 63c in the circumferential direction of the first housing 61. That is, in the first housing 61, the suction passages 61e are each disposed between the corresponding bolt insertion hole 63a and the corresponding fixing hole 63b in a circumferential direction of the first end surface 61c, and by extension, in the circumferential direction of the first housing 61. More specifically, in the first housing 61, the bolt insertion hole 63a, the suction passage 61e, and the fixing hole 63b are arranged in this order in a rotational direction R1 of a rotor 8b and the driving shaft 5 illustrated in FIGS. 5 and 8. Note that in FIG. 5, the driving shaft 5 is drawn by an imaginary line for ease of explanation.

As illustrated in FIG. 4, the second housing 62 is disposed at a front of the first housing 61. The second housing 62 has a front wall 62a and a peripheral wall 62b.

The front wall 62a is located at a front end of the second housing 62 and extends in a radial direction of the second housing 62. The peripheral wall 62b is formed in a cylindrical shape extending around the driving axis O as the center axis. The peripheral wall 62b is connected to the front wall 62a and extends rearward from the front wall 62a. The front wall 62a and the peripheral wall 62b cooperate to form the second housing 62, which has a bottomed cylindrical shape that is open in the rear direction of the compressor.

The second housing 62 also has a second end surface 62c, an attachment leg 62d, and an attachment leg 62e. The second end surface 62c is a rear end surface of the peripheral wall 62b. That is, the second end surface 62c is located at a rear end of the second housing 62.

Six fixing holes 66 are formed in the second end surface 62c. Although detailed illustrations are omitted, the fixing holes 66 are arranged at regular intervals in a circumferential direction of the second housing 62 so as to correspond to the bolt insertion holes 63a, are open in the second end surface 62c, and extend into the peripheral wall 62b. Thread grooves are formed in the fixing holes 66, and the housing fixing bolts 25b are screwed into the fixing holes 66 to be engaged with the thread grooves. Note that one of the six fixing holes 66 is illustrated in FIG. 4.

In addition, two positioning pins 64 (see FIG. 8) that protrude rearward are fixed to the second end surface 62c.

As illustrated in FIG. 4, the attachment legs 62d, 62e protrude from an outer peripheral surface of the peripheral wall 62b toward the outside of the second housing 62 in the radial direction of the second housing 62. The attachment legs 62d and 62e are disposed away from the second end surface 62c in the front direction of the compressor.

The second housing 62 also has a suction connection port 62f, a supporting portion 62g, and a communication port 62h. The suction connection port 62f is formed in the peripheral wall 62b and is located in front of the attachment legs 62d, 62e. The suction connection port 62f extends through the peripheral wall 62b in the radial direction of the second housing 62. Similarly to the suction connection port 13c, a pipe, which is not illustrated, is connected to the suction connection port 62f.

The supporting portion 62g and the communication port 62h are formed in the front wall 62a. The supporting portion 62g and the communication port 62h have the same configurations as those of the supporting portion 13d and the communication port 13e in the compressor of the first embodiment, respectively. The first radial bearing 24 is provided inside the supporting portion 62g.

In the housing 2, a gasket 20 is provided between the first end surface 61c of the first housing 61 and the second end surface 62c of the second housing 62. The gasket 20 is an example of the “sealing member” in the present disclosure. Similarly to the gasket 18, the gasket 20 is formed in a plate shape.

Although detailed illustrations are omitted, the gasket 20 has substantially the same configuration as that of the gasket 18 in the compressor of the first embodiment. That is, the gasket 20 has through holes that are aligned with the bolt insertion holes 63a, through holes that are aligned with the positioning holes 63c, and ribs that are located on an inner side of the through holes in the radial direction of the gasket 20 and make one round on the gasket 20 in a circumferential direction thereof.

The gasket 20 is formed such that the gasket 20 keeps away from the fixing holes 63b and portions near the fixing holes 63b in the first end surface 61c on an outer side thereof in the radial direction of the compressor. With this configuration, the gasket 20 is formed such that the gasket 20 does not overlap the fixing holes 63b and the portions near the fixing holes 63b in the first end surface 61c in the front and rear direction of the compressor.

Although not illustrated, in the housing 2, a gasket is also provided between the rear wall 61a of the first housing 61 and the third housing 15.

In the housing 2, the first, second, and third housing 61, 62, 15 and the gasket 20 are fixed by the six housing fixing bolts 25b. Here, when the first, second, and third housings 61, 62, 15 and the gasket 20 are fixed with each other, firstly, the second housing 62, the first housing 61, and the third housing 15 are arranged in this order from a front side of the compressor toward a rear side of the compressor. In addition, the gasket 20 is disposed between the first end surface 61c of the first housing 61 and the second end surface 62c of the second housing 62, and the gasket is disposed between the rear wall 61a of the first housing 61 and a front end surface of the peripheral wall 15b of the third housing 15.

The first housing 61 and the second housing 62 are positioned relative to each other by inserting the positioning pins 64 into the respective positioning holes 63c. Similarly to the first housing 61 and the second housing 62, the first housing 61 and the third housing 15 are positioned relative to each other.

Then, the housing fixing bolts 25b are inserted into the respective bolt insertion holes 151 from the third housing 15 toward the first housing 61. Thus, the housing fixing bolts 25b are inserted into the fixing holes 66 through the bolt insertion holes 151 and the bolt insertion holes 63a, and screwed into the fixing holes 66 formed in the second end surface 62c to be fixed in the fixing holes 66, so that the first, second, third housing 61, 62, 15 and the gasket 20 are fixed with each other.

In the housing 2, the inverter housing 12 is fixed to the front wall 62a of the second housing 62 by bolts, which are not illustrated. An aspect of fixing the inverter housing 12 to the second housing 62 is the same as that of fixing the inverter housing 12 to the first housing 13 in the compressor of the first embodiment. Thus, in the housing 2, the inverter housing 12, the second housing 62, the first housing 61, and the third housing 15 are arranged in this order from the front side of the compressor toward the rear side of the compressor.

In the housing 2, the first end surface 61c of the first housing 61 faces the second end surface 62c of the second housing 62 through the gasket 20 in the front and rear direction of the compressor. In the housing 2, the first housing 61 and the second housing 62 cooperate to form a suction chamber 2a. The suction chamber 2a is defined by the first housing 61, the second housing 62, and the gasket 20 and divided from the outside of the housing 2. Here, the gasket 20 seals the suction chamber 2a against the outside of the housing 2. The suction chamber 2a communicates with the suction connection port 62f. With this configuration, refrigerant is suctioned from the outside of the housing 2 into the suction chamber 2a through the pipe connected to the suction connection port 62f. In addition, the suction chamber 2a communicates with the suction passages 61e. Accordingly, the refrigerant in the suction chamber 2a is sucked into the compression chamber 49 through the suction passages 61e and the suction port 9f.

In the housing 2, an inverter chamber 4a is formed inside the peripheral wall 12b of the inverter housing 12 and between the front wall 62a of the second housing 62 and the front wall 12a of the inverter housing 12. The inverter 3 is accommodated in the inverter chamber 4a.

The electric motor 8 is formed of a stator 8a and the rotor 8b. The stator 8a includes a stator core 80, the first insulator 71, the second insulator 72, the plurality of coils 73, and a cover 76.

Similarly to the stator core 70 in the compressor of the first embodiment, the stator core 80 is made of metal, and extends in a substantially cylindrical shape in the front and rear direction of the compressor around the driving axis O as the center axis. As illustrated in FIGS. 6 to 8, six attachment flanges 80a are formed in the stator core 80. The attachment flanges 80a protrude from an outer peripheral surface 180 of the stator core 80 toward an outer side of the stator core 80 in a radial direction thereof. As illustrated in FIG. 8, the attachment flanges 80a are arranged at regular intervals in a circumferential direction of the stator core 80. As illustrated in FIG. 6, the attachment flanges 80a have insertion holes 80b into which the stator fixing bolts 26b are inserted. The insertion holes 80b extend through the attachment flanges 80a in the front and rear direction of the compressor. As illustrated in FIG. 8, teeth 80c are formed inside the stator core 80 in the radial direction thereof. Note that an illustration of the second housing 62 is omitted as well as a shape of the stator 8a or the like is illustrated in a simplified manner for ease of explanation in FIG. 8.

As illustrated in FIG. 4, the first insulator 71 is disposed at a rear end of the stator core 80 and the second insulator 72 is disposed at a front end of the stator core 80.

As illustrated in FIG. 6, similarly to the cover 74 in the compressor of the first embodiment, the cover 76 is made of resin such as PPS and has an electrical insulation property and heat resistance. The cover 76 is attached to the rear end of the stator core 80, and covers a rear end of the first insulator 71 and the coil ends 73a on the rear side thereof in the radial direction of the compressor.

As illustrated in FIGS. 6 and 7, six holding portions 76a are formed in the cover 76. As illustrated in FIG. 7, the holding portions 76a project from an outer circumferential surface 176 of the cover 76 toward an outer side of the stator core 80 in the radial direction of the compressor. As illustrated in FIG. 6, sleeves 83 are provided inside the holding portions 76a. The sleeves 83 are made of metal and each formed in a cylindrical shape extending in the front and rear direction of the compressor. A length of each of the sleeves 83 in the front and rear direction of the compressor is substantially the same as that of each of the holding portions 76a in the front and rear direction of the compressor. The stator fixing bolts 26b are inserted through the sleeves 83.

In the stator 8a, the cover 76 is attached to the rear end of the stator core 80, and thus, the sleeves 83 and the holding portions 76a face the attachment flanges 80a of the stator core 80 in the front and rear direction of the compressor. With this configuration, the inside of the sleeves 83 communicates with the insertion holes 80b of the attachment flanges 80a while the sleeves 83 is in contact with the attachment flanges 80a.

As illustrated in FIG. 4, the rotor 8b is rotatably disposed inside the stator 8a. The rotor 8b has the same configuration as that of the rotor 7b in the compressor of the first embodiment, and the large diameter portion 5b of the driving shaft 5 is fixed by shrink fitting.

In this compressor, the stator core 80, and by extension, the stator 8a, is fixed to the first end surface 61c of the first housing 61. When the stator core 80 is fixed to the first end surface 61c, the stator fixing bolts 26b are inserted into the insertion holes 80b from the attachment flanges 80a toward the first housing 61. Then, the stator fixing bolts 26b are inserted into the sleeves 83 through the insertion holes 80b. Here, the rear ends pf the holding portions 76a are brought into contact with the first end surface 61c. This brings the sleeves 83 into contact with the first end surface 61c on a side opposite to the attachment flanges 80a. In this state, the stator fixing bolts 26b are screwed into the fixing holes 63b to be fixed in the fixing holes 63b. Thus, the stator core 80 is fixed to the first end surface 61c through the holding portions 76a and the sleeves 83.

Here, in the first end surface 61c, the fixing holes 63b are disposed on an inner side of the bolt insertion holes 63a in the radial direction of the compressor. Accordingly, as illustrated in FIG. 4, the stator core 80 is fixed to the first end surface 61c, and by extension, to the first housing 61, by the stator fixing bolts 26b on an inner side of the housing fixing bolts 25b in the radial direction of the first housing 61. The stator core 80 of the stator 8a is fixed to the first end surface 61c by the stator fixing bolts 26b on an outer side of the first and second insulators 71, 72 and the coil ends 73a in the radial direction of the compressor.

Thus, in the compressor, the stator 8a and the rotor 8b, that is, the electric motor 8, is disposed in the suction chamber 2a by fixing the stator core 80 to the first end surface 61c. The stator 8a is connected to the inverter 3 in the inverter chamber 4a through the connection terminal 3c inserted into the communication port 62h through the hermetically sealing member 3d. The small diameter portion 5a of the driving shaft 5 is rotatably supported by the supporting portion 62g through the first radial bearing 24 in the suction chamber 2a, and the large diameter portion 5b of the driving shaft 5 is rotatably supported by the second radial bearing 27 with the rear end portion of the large diameter portion 5b inserted into the boss 61d.

In this compressor, the thrust plate 51 is provided between the movable scroll 11 and the rear wall 61a of the first housing 61. The movable scroll base plate 11a and the thrust plate 51 cooperate to form the back-pressure chamber 53 in the boss 61d. The other configurations of this compressor are similar to those of the compressor of the first embodiment. The same configurations have the same reference numerals and detail explanations regarding the configurations will be omitted.

In this compressor, the stator core 80 of the stator 8a is fixed to the first end surface 61c of the first housing 61 by the stator fixing bolts 26b. Thus, in this compressor, the first end surface 61c serves as a fixing portion for fixing the stator 8a. With this configuration, in this compressor, a fixing portion exclusively for the stator 8a need not be formed in the peripheral wall 61b of the first housing 61 such that the fixing portion partly protrudes into the suction chamber 2a. Accordingly, similarly to the compressor of the first embodiment, it is suppressed that the first housing 61 is increased in size also in this compressor.

By the way, in this compressor, the stator core 80 is fixed to first end surface 61c with the holding portions 76a of the cover 76 disposed between the stator core 80 and the first end surface 61c. Here, the cover 76 including the holding portions 76a need be made of an insulating material such as PPS in order to ensure an insulation property. However, it is difficult to ensure stiffness in such a cover 76 made of the insulating material compared to the cover 76 made of metal. As a result, it is concerned that the holding portions 76a, and by extension, the cover 76, is damaged by a load applied when the stator core 80 is fixed to the first end surface 61c, that is, a fastening force of the stator fixing bolts 26b applied when the stator fixing bolts 26b are screwed into the fixing holes 63b.

As for this concern, in this compressor, the sleeves 83 made of metal are provided in the holding portions 76a of the cover 76, and the stator core 80 of the stator 8a is fixed to the first end surface 61c with the holding portions 76a and the sleeves 83 interposed between the stator core 80 and the first end surface 61c. That is, in this compressor, the sleeves 83 are in contact with the first end surface 61c and the attachment flanges 80a of the stator core 80 on the opposite sides of the sleeves 83. Accordingly, in this compressor, even when the holding portions 76a are held by the first end surface 61c and the attachment flanges 80a therebetween in the front and rear direction of the compressor by the fastening force of the stator fixing bolts 26b applied when the stator fixing bolts 26b are screwed into the fixing holes 63b, the holding portions 76a are supported by the sleeves 83. Thus, in this compressor, the holding portions 76a, and by extension, the cover 76, is hardly damaged when the stator fixing bolts 26b are screwed into the fixing holes 63b. As a result, in this compressor, the stator core 80 is firmly fixed to the first end surface 61c by the stator fixing bolts 26b.

In this compressor, the first housing 61 and the second housing 62 cooperate to form the suction chamber 2a, and the suction chamber 2a is divided from the outside of the housing 2 to be a space sealed against the outside of the housing 2. In addition, the gasket 20 is provided between the first end surface 61c and the second end surface 62c. With this configuration, in this compressor, the refrigerant in the suction chamber 2a hardly leaks to the outside of the housing 2 from a space between the first end surface 61c and the second end surface 62c.

In this compressor, each of the bolt insertion holes 63a, each of the suction passages 61e, and each of the fixing holes 63b are arranged in this order in the rotational direction R1 of the rotor 8b and the driving shaft 5. With this arrangement, the suction passages 61e are suitably formed in the first housing 61, so that a pressure loss of the refrigerant when the refrigerant flows through the suction passages 61e is suitably suppressed. Other operations in this compressor are the same as those of the compressor in the first embodiment.

In the above description, the present disclosure has been described based on the first embodiment and the second embodiment. However, the present disclosure is not limited to the above-described first embodiment and the second embodiment, and may be modified as appropriate within the scope of the present disclosure.

For example, the compression mechanism 10 may be a so-called co-rotating scroll type compression mechanism in which a first scroll and a second scroll rotate while engaged with each other. In addition, the compression mechanism 10 may be a vane type compression mechanism or a piston type compression mechanism.

In the compressor of the first embodiment, the second housing 14 and the fixed block 16 may be formed integrally with each other. In addition, the second housing 14 and the third housing 15 may be formed integrally with each other, and the fixed scroll 9, the movable scroll 11, and the fixed block 16 may be disposed inside the second housing 14 and the third housing 15 that are formed integrally.

In the compressor of the first embodiment, each of the housing fixing bolts 25a corresponds to the “first fastener” in the present disclosure, and each of the stator fixing bolts 26a corresponds to the “second fastener” in the present disclosure. However, the present disclosure is not limited to this aspect, and press-fitting pins or the like may be used as the “first fastener” and “second fastener” in the present disclosure. The same goes for the compressor of the second embodiment.

In the compressor of the first embodiment, the first housing 13, the second housing 14, and the inverter housing 12 may be fixed by a plurality of housing fixing bolts, which are inserted from the inverter housing 12, and the third housing 15, the fixed block 16, and the second housing 14 may be fixed by another plurality of housing fixing bolts different from the above-described housing fixing bolts, which are inserted from the third housing 15.

In the compressor of the first embodiment, the gasket 18 corresponds to the “sealing member” in the present disclosure. However, the present disclosure is not limited to this aspect. An O-ring or the like may be provided between the first end surface 13f and the second end surface 14a, and this O-ring or the like may be used as the “sealing member” in the present disclosure. The same goes for the compressor of the second embodiment.

In the compressor of the first embodiment or the second embodiment, carbon dioxide may be used as the refrigerant. When carbon dioxide is used as the refrigerant, pressure inside the suction chamber 1a or the suction chamber 2a becomes higher. In this case, the advantageous effects of the compressor of the first embodiment or the second embodiment become more significant. That is, in the compressor of the first embodiment or the second embodiment, the first end surface 13f or the first end surface 61c serves as the fixing portion for the stator 7a or the stator 8a, respectively, and thus, the first housing 13 or the first housing 61 need not be increased in size in order to ensure stiffness of the fixing portion such that the fixing portion tolerates the high pressure in the suction chamber 1a or the suction chamber 2a. In addition, even when the pressure in the suction chamber 1a or the suction chamber 2a becomes higher, the carbon dioxide in the suction chamber 1a or the suction chamber 2a hardly leaks to the outside of the housing 1 or the outside of the housing 2 due to the gasket 18 or the gasket 20.

In the compressor of the first embodiment, the first housing 13 may have attachment legs. In this case, the attachment legs may be preferably disposed on the peripheral wall 13b at a position in front of the first end surface 13f. In the compressor of the second embodiment, the first housing 61 may have attachment legs. In this case, the attachment legs may be preferably disposed on the peripheral wall 61b at a position behind the first end surface 61c.

In the compressor of the second embodiment, the stator core 80 is fixed to the first end surface 61c by the stator fixing bolts 26b with the holding portions 76a and the sleeves 83 interposed between the stator core 80 and the first end surface 61c. However, the present disclosure is not limited to this aspect. The holding portions 76a of the cover 76 in addition to the sleeves 83 may be omitted, and the stator core 80 may be fixed to the first end surface 61c by the stator fixing bolts 26b while the attachment flanges 80a of the stator core 80 are directly brought into contact with the first end surface 61c on the outer side of the cover 76 in the radial direction of the compressor.

In this compressor of the second embodiment, each of the bolt insertion holes 63a, each of the suction passages 61e, and each of the fixing holes 63b are arranged in this order in the rotational direction R1 of the rotor 8b and the driving shaft 5. However, the present disclosure is not limited to this aspect, and each of the fixing holes 63b, each of the suction passages 61e, and each of the bolt insertion holes 63a may be arranged in this order in the rotational direction R1 of the rotor 8b and the driving shaft 5.

### INDUSTRIAL APPLICABILITY

The present disclosure is applicable to an air conditioner for a vehicle or the like.

What is claimed is:

1. An electric compressor comprising:
a housing;
a driving shaft;
an electric motor that rotates the driving shaft; and
a compression mechanism that is driven with rotation of the driving shaft to compress refrigerant,
the housing including a first housing extending in an axial direction of the driving shaft and a second housing fixed to the first housing in the axial direction,
the electric motor including a stator formed in a cylindrical shape and a rotor that is rotatable inside the stator,
the first housing and the second housing cooperating to form a suction chamber that is divided from an outside of the housing and into which the refrigerant is sucked,
the first housing having a first end surface facing the second housing in the axial direction,
the second housing having a second end surface facing the first end surface in the axial direction,
a sealing member being provided between the first end surface and the second end surface and sealing the suction chamber against the outside of the housing,
the first housing and the second housing being fixed with each other by a first fastener, wherein
the stator is disposed in the suction chamber and fixed to the first end surface by a second fastener in the axial direction, and
the first end surface has a first hole which the first fastener is inserted through or fixed in and a second hole in which the second fastener is fixed.

2. The electric compressor according to claim 1 further comprising
an inverter that drives and controls the electric motor, wherein
the housing includes an inverter housing in which the inverter is accommodated, and
the inverter housing is fixed to the first housing or the second housing in the axial direction.

3. The electric compressor according to claim 1, wherein
the stator includes a stator core formed in a cylindrical shape extending in the axial direction and coil ends protruding from end surfaces of the stator core in the axial direction, and
the stator core is fixed to the first end surface on an outer side of the coil ends by the second fastener.

4. The electric compressor according to claim 3, wherein
the stator includes a cover covering one side of the coil ends, the cover being made of an insulating material,
the cover has a sleeve through which the second fastener is inserted, the sleeve being made of metal, and
the stator core is fixed to the first end surface with the cover and the sleeve interposed between the stator core and the first end surface.

5. The electric compressor according to claim 1, wherein
the first end surface has a suction passage through which the refrigerant flows, and
the suction passage is disposed between the first hole and the second hole in a circumferential direction of the first end surface.

6. The electric compressor according to claim 1, wherein
at least one of the first housing or the second housing has an attachment leg attached to a mounting object, and
the attachment leg is disposed away from the first end surface and the second end surface in the axial direction.
